(19) United States
(12) Patent Application Publication
(10) Pub. No.: US 2010/0299087 A1
(43) Pub. Date: Nov. 25, 2010

(54) METHOD FOR DIAGNOSING PRESSURE SENSORS OF AN AIR SUPPLY OF AN INTERNAL COMBUSTION ENGINE

(76) Inventors: Patrick MENOLD, Stuttgart (DE); Soenke Mannal, Stuttgart (DE)

Correspondence Address: KENYON & KENYON LLP, ONE BROADWAY, NEW YORK, NY, 10004, US

(21) Appl. No.: 12/783,087

(22) Filed: May 19, 2010

(30) Foreign Application Priority Data
May 20, 2009 (DE) 102009003285.1

(51) Int. Cl. G01M 15/04; G01F 1/34

(52) U.S. Cl. 702/47; 73/114.37

(57) ABSTRACT

A method for diagnosing pressure sensors of an air supply of an internal combustion engine, the air supply having an intake port, which, viewed in the air supply direction, leads into at least two sub-ports, via which air is suppliable to different cylinder banks of the internal combustion engine, a first pressure sensor being assigned to a first sub-port, a second pressure sensor being assigned to a second sub-port, and a third pressure sensor being assigned to the intake port, a first air mass flow associated with the first pressure sensor, a second air mass flow associated with the second pressure sensor and a third air mass flow associated with the third pressure sensor being ascertained, pressure values ascertained by the first pressure sensor and the second pressure sensor being compared to each other and the sum of the first air mass flow and the second air mass flow being compared to the third air mass flow.

### FIELD OF THE INVENTION

The present invention relates to a method for diagnosing pressure sensors of an air supply of an internal combustion engine, the air supply having an intake port, which, viewed in the direction of the air supply, leads into at least two sub-ports, via which air is suppliable to different cylinder banks of the internal combustion engine, a first pressure sensor being assigned to a first sub-port, a second pressure sensor being assigned to a second sub-port, and a third pressure sensor being assigned to the intake port.

The present invention also relates to a computer program and a control unit for an internal combustion engine.

### BACKGROUND INFORMATION

In order to comply with statutory requirements, it is necessary to be able to check the functional integrity of actuators and/or sensors, which as part of an air supply of an internal combustion engine have at least an indirect effect on the emissions of the internal combustion engine. If such an internal combustion engine has a plurality of cylinder banks, these cylinder banks are supplied with combustion air via sub-ports when the internal combustion engine is in operation. The pressure prevailing in the sub-ports is detected with the aid of respectively assigned pressure sensors.

### SUMMARY OF THE INVENTION

An objective of the present invention is to provide a method that allows for a simple check of the functioning of the pressure sensors.

In a method of the kind mentioned at the outset, this objective is achieved according to the present invention in that a first air mass flow associated with the first pressure sensor, a second air mass flow associated with the second pressure sensor, and a third air mass flow associated with the third pressure sensor are ascertained, that pressure values ascertained by the first pressure sensor and the second pressure sensor are compared to each other and that the sum of the first air mass flow and of the second air mass flow is compared to the third air mass flow.

The method according to the present invention allows for the pressure sensors to be checked continuously for plausibility. By comparing the pressure values ascertained with the aid of the first pressure sensor and of the second pressure sensor, inadmissibly high deviations may be ascertained. Furthermore, a check is performed as to whether a first mass flow associated with the first pressure sensor and a second mass flow associated with the second pressure sensor in sum correspond at least essentially to the third mass flow associated with the third pressure sensor. If this condition is fulfilled as well, then the functional integrity of all three pressure sensors may be inferred.

Advantageously, a maximum pressure value difference is specified. If the absolute value of the difference of the pressure values ascertained by the first pressure sensor and by the second pressure sensor exceeds this maximum pressure value difference, then a defect of the first pressure sensor or of the second pressure sensor may be inferred.

Furthermore, it is advantageous to specify a maximum air mass flow difference between the sum of the first air mass flow and the second air mass flow on the one hand and the third air mass flow on the other hand. When the maximum air mass flow difference is exceeded, the third pressure sensor is assumed to be defective.

Another specific embodiment of the present invention provides for a specified portion of the third air mass flow to be compared to the first air mass flow or to the second air mass flow. This makes it possible to check the plausibility of the air mass flows, it being assumed that an air mass flow existing in the intake port divides into the different sub-ports.

The specified portion is preferably determined by taking the flow cross sections of the sub-ports into account. In the simplest case, the flow cross sections of the sub-ports are of equal size such that the portion results by dividing the flow cross section of a sub-port and the flow cross section of the intake port.

It is furthermore advantageous if a maximum air mass flow difference is specified between the portion of the third air mass flow on the one hand and respectively the first air mass flow and the second air mass flow on the other hand. If the maximum air mass flow difference is undershot, a defect of the second pressure sensor or respectively of the first pressure sensor may be inferred.

According to one specific embodiment of the present invention, the third pressure sensor is situated in front of a throttle valve situated in the intake port in the direction of the air supply. This makes it possible to calculate the third mass flow by using the degree of closure or the throttle valve angle of the throttle valve.

It is possible for the third pressure sensor to detect the pressure in the intake port. It is also possible, however, that the third pressure sensor detects an ambient pressure, by which the pressure in the intake port is then determined, for example using an empirically determined characteristics map.

An air mass flow associated with a specific pressure sensor is preferably ascertained by using the pressure value of this pressure sensor. Thus the first mass flow may be determined, for example, by using the pressure value of the first pressures sensor as well as an air mass flow curve, which represents a correlation between a stroke volume of a first cylinder bank, the first pressure value and a first mass flow setting in as a function of the rotational speed of the internal combustion engine. The second mass flow may be ascertained in a similar manner. The third mass flow may be determined for example by using an experimentally determined correlation between the pressure values of the third pressure sensor, a throttle valve angle and possibly the temperature of the air in the intake port.

Especially significant is the implementation of the method according to the present invention in the form of a computer program, which may be stored on an electronic storage medium and which in this form may be assigned to a control unit that controls the internal combustion engine.

### BRIEF DESCRIPTION OF THE DRAWINGS

FIG. 1 shows a schematic representation of an internal combustion engine and an air supply having a plurality of pressure sensors.

FIG. 2 shows a schematic representation of a sequence for diagnosing errors of the pressure sensors.

### DETAILED DESCRIPTION

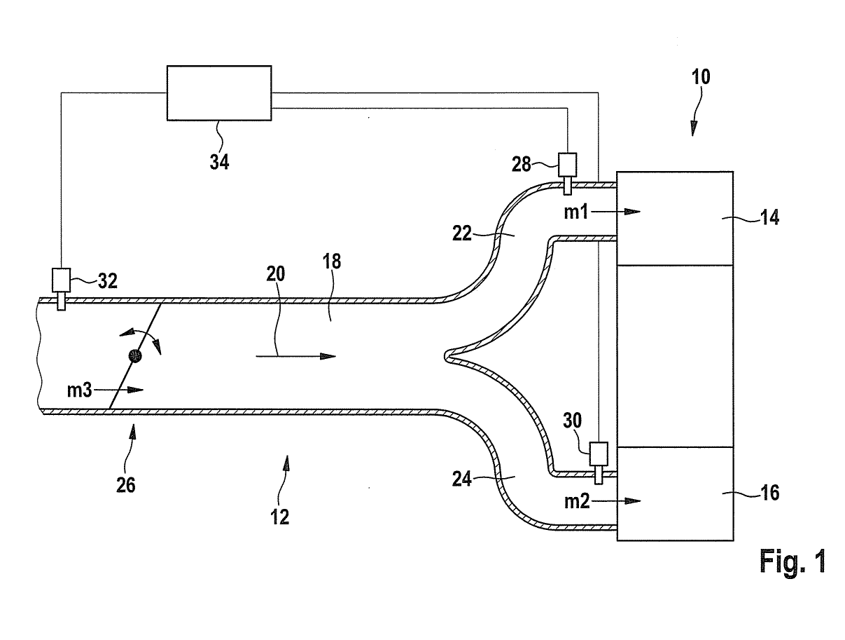

FIG. 1 schematically shows an internal combustion engine 10 and an air supply 12. Internal combustion engine 10 comprises a plurality of cylinder banks, in particular a first cylinder bank 14 and a second cylinder bank 16. Internal combustion engine 10 is preferably an internal combustion engine having six cylinders, but it also conceivable that each cylinder bank has respectively only one or two cylinders.

Air supply 12 comprises an intake port 18, through which air flows in an air supply direction 20. This may be fresh air or a mixture of fresh air and exhaust gas recirculated from internal combustion engine 10.

Intake port 18 leads into two sub-ports 22 and 24, which respectively supply air to one of cylinder banks 14 and 16.

To set the air quantity that is supplied to internal combustion engine 10, a throttle valve 26 is provided that is disposed in intake port 18.

Air supply 12 comprises a plurality of pressure sensors, that is, a first pressure sensor 28 for detecting a pressure prevailing in first sub-port 22, a second pressure sensor 30 for detecting a pressure prevailing in second sub-port 24, and a third pressure sensor 32 for detecting a pressure prevailing in intake port 18. Third pressure sensor 32 is preferably disposed in front of throttle valve 26 viewed in air supply direction 20. In an alternative specific embodiment, not shown in the drawing, third pressure sensor 32 is used to detect an ambient pressure, by which then a pressure prevailing in intake port 18 in front of throttle valve 26 is ascertained.

A control unit 34 is provided to evaluate the signals of pressure sensors 28, 30 and 32. Control unit 34 is also used to control throttle valve 26 as well as an injector device, known per se but not shown in the drawing, for injecting fuel into combustion chambers of internal combustion engine 10.

Using first pressure sensor 28, a first pressure value p1 may be determined, using second pressure sensor 30 a second pressure value p2 may be determined, and using third pressure sensor 32 a third pressure value p3 may be determined.

Using first pressure value p1 and using an air mass flow curve, which reflects a correlation between the stroke volume of cylinder bank 14 and first pressure value p1, it is possible to ascertain a first mass flow m1 as a function of the rotational speed of internal combustion engine 10. Mass flow m1 flows through first sub-port 22.

A second mass flow m2 flowing through second sub-port 24 may be ascertained in a corresponding manner on the basis of knowing pressure value p2 and the stroke geometry of the combustion chambers of second cylinder bank 16 and the rotational speed of internal combustion engine 10.

A third mass flow m3, which flows through intake port 18, may be ascertained as a function of pressure value p3, the degree of closure of throttle valve 26 and the temperature of the air flowing through intake port 18, in particular by using a characteristics map.

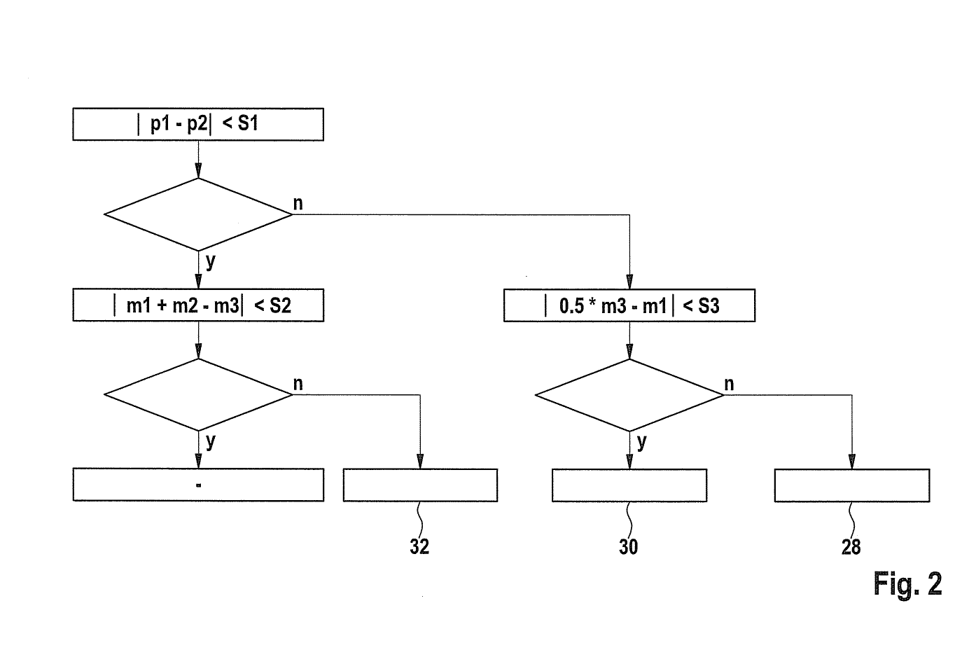

In order to be able to diagnose faults of pressure sensors 28, 30 and 32, a method schematically shown in FIG. 2 is carried out. First, pressure values p1 and p2 of first pressure sensor 28 and of second pressure sensor 30, respectively, are compared to each other, in particular subtracted from each other. If the absolute value of the difference between these values falls below a specifiable first threshold value S1, it is assumed that first pressure sensor 28 and second pressure sensor 30 are in working order. First threshold value S1 thus indicates a maximum pressure difference between pressure values p1 and p2.

If first threshold value S1 is maintained, a check may be performed in a next step as to whether the sum of first mass flow m1 and of second mass flow m2 corresponds at least approximately to third mass flow m3. For this purpose, mass flows m1 and m2 are added to each other and third mass flow m3 is subtracted from this sum. If the absolute value of the resulting difference does not exceed a second threshold value S2, it is assumed that all three pressure sensors 28, 30 and 32 are in working order. If limit value S2 is exceeded, a defect of third pressure sensor 32 is inferred.

In the event that in connection with the comparison of pressure values p1 and p2 it is ascertained that first threshold value S1 is exceeded, a defect of first pressure sensor 28 or a defect of second pressure sensor 30 may be assumed. In order to determine which of the two pressure sensors is defective, a portion of third mass flow m3 and for example first mass flow m1 are compared to each other. If sub-ports 22 and 24 have the same flow cross section, it is assumed that third mass flow m3 divides into mass flows m1 and m2 of equal magnitude. In this case, the portion of the third mass flow therefore is 50% or 0.5. In the event that the absolute value of the difference ascertained above falls below a third threshold value S3, it may be assumed that first pressure sensor 28 is in working order and that second pressure sensor 30 is defective. An exceedance of third threshold value S3 results in the diagnosis of a defective first pressure sensor 28.

Of course, in the context of the comparison with third threshold value S3 it is also possible to compare a portion of the third mass flow with the second mass flow, the adherence to such a comparison condition being equated to a non-functional first pressure sensor 28 and the non-adherence to such a comparison condition being equated to a defective second pressure sensor 30.

What is claimed is:

1. A method for diagnosing pressure sensors of an air supply of an internal combustion engine, the air supply having an intake port, which, viewed in an air supply direction, leads into at least two sub-ports, via which air is suppliable to different cylinder banks of the internal combustion engine, a first pressure sensor being assigned to a first sub-port, a second pressure sensor being assigned to a second sub-port, and a third pressure sensor being assigned to the intake port, the method comprising:
ascertaining a first air mass flow associated with the first pressure sensor, a second air mass flow associated with the second pressure sensor and a third air mass flow associated with the third pressure sensor;
comparing pressure values ascertained by the first pressure sensor and by the second pressure sensor to each other; and
comparing a sum of the first air mass flow and the second air mass flow to the third air mass flow.

2. The method according to claim 1, wherein a maximum pressure value difference is specified.

3. The method according to claim 1, wherein a maximum air mass flow difference between the sum of the first air mass flow and the second air mass flow on the one hand and the third air mass flow on the other hand is specified.

4. The method according to claim 1, further comprising comparing a specified portion of the third air mass flow to the first air mass flow or to the second air mass flow.

5. The method according to claim 4, wherein the specified portion is determined by taking flow cross sections of the sub-ports into account.

6. The method according to claim 4, wherein a maximum air mass flow difference between the portion of the third air mass flow on the one hand and the first air mass flow or the second air mass flow on the other hand is specified.

7. The method according to claim 1, wherein the third pressure sensor is situated in the air supply direction in front of a throttle valve situated in the intake port.

8. The method according to claim 1, wherein the third pressure sensor detects a pressure in the intake port.

9. The method according to claim 1, wherein the third pressure sensor detects an ambient pressure, with the aid of which a pressure in the intake port is determined.

10. The method according to claim 1, wherein, for ascertaining an air mass flow associated with a specific pressure sensor, a pressure value of the specific pressure sensor is used.

11. A computer-readable medium containing a computer program which, when executed by a processor, performs a method for diagnosing pressure sensors of an air supply of an internal combustion engine, the air supply having an intake port, which, viewed in an air supply direction, leads into at least two sub-ports, via which air is suppliable to different cylinder banks of the internal combustion engine, a first pressure sensor being assigned to a first sub-port, a second pressure sensor being assigned to a second sub-port, and a third pressure sensor being assigned to the intake port, the method comprising:
ascertaining a first air mass flow associated with the first pressure sensor, a second air mass flow associated with the second pressure sensor and a third air mass flow associated with the third pressure sensor;
comparing pressure values ascertained by the first pressure sensor and by the second pressure sensor to each other; and
comparing a sum of the first air mass flow and the second air mass flow to the third air mass flow.

12. A control unit for diagnosing pressure sensors of an air supply of an internal combustion engine, the air supply having an intake port, which, viewed in an air supply direction, leads into at least two sub-ports, via which air is suppliable to different cylinder banks of the internal combustion engine, a first pressure sensor being assigned to a first sub-port, a second pressure sensor being assigned to a second sub-port, and a third pressure sensor being assigned to the intake port, the control unit comprising:
an arrangement for ascertaining a first air mass flow associated with the first pressure sensor, a second air mass flow associated with the second pressure sensor and a third air mass flow associated with the third pressure sensor;
an arrangement for comparing pressure values ascertained by the first pressure sensor and by the second pressure sensor to each other; and
an arrangement for comparing a sum of the first air mass flow and the second air mass flow to the third air mass flow.
